(19) United States
(12) Patent Application Publication
(10) Pub. No.: US 2025/0016849 A1
(43) Pub. Date: Jan. 9, 2025

(54) STORAGE MEDIUM STORING APPLICATION PROGRAM CAPABLE OF INTER-APPLICATION COOPERATION, ELECTRONIC DEVICE, AND CONTROL METHOD THEREOF

(71) Applicant: CANON KABUSHIKI KAISHA, Tokyo (JP)

(72) Inventor: HIROYOSHI IWAYAMA, Kanagawa (JP)

(21) Appl. No.: 18/761,398

(22) Filed: Jul. 2, 2024

(30) Foreign Application Priority Data
Jul. 6, 2023 (JP) 2023-111653

(51) Int. Cl. H04W 76/10; G06F 9/54; H04M 1/72403

(52) U.S. Cl. CPC H04W 76/10; G06F 9/547; H04M 1/72403

(57) ABSTRACT

Data transmission to an external apparatus can occur more appropriately when a cooperation source application in which a second network is set performs an inter-application cooperating operation with a cooperation destination application. A computer-readable storage medium stores a first application program causing at least one computer to function as a setting unit that sets a second network as a connection destination in transmitting data to an external apparatus, the second network being different from a first network managed by an operating system as a connection destination, a reception unit that receives a cooperation instruction with a second application program, and a processing unit that executes a specific process causing the second application program to obtain the connection information for connecting to the second network set by the setting unit when a process of the second application program is executed based on the cooperation instruction received by the reception unit.

### BACKGROUND OF THE INVENTION

### Field of the Invention

The present invention relates to a storage medium storing an application program capable of inter-application cooperation, an electronic device, and a control method thereof.

### Description of the Related Art

A technique what is called inter-program cooperation that cooperatively operates programs, such as applications installed in an information processing apparatus, such as a mobile terminal or a smartphone, is used. Specifically, the inter-program cooperation enables a process based on information handled by a predetermined program to be executed in a program different from the predetermined program.

Japanese Patent Laid-Open Publication No. 2016-18285 (JP 2016-18285A) discloses a technique that a first application activates a second application using a URL scheme to which a parameter, such as a print setting, is added. Thus, the information is shared between the first application and the second application. That is, the technique related to the inter-application cooperation is disclosed. Further, Japanese Patent Laid-Open Publication No. 2017-10089 (JP2017-10089A) discloses a technique for suppressing a sense of discomfort in a displayed screen when a different application is activated in activation of the inter-application cooperation. In the activation of the inter-application cooperation, a seamless cooperation operation and a seamless display operation as if one application is operating are important elements for improving usability.

In particular, as disclosed in the above-mentioned two publications, an application that performs a process by communicating with an external apparatus is required to seamlessly exchange setting information and communication data of the external apparatus.

In addition, AOSP Docs Wi-Fi STA/STA Concurrency (Internet URL: https://source.android.com/docs/core/connect/wifi-sta-sta-concurrency)) discloses a technique that allows a smartphone to simultaneously connect to two Wi-Fi (registered trademark) networks using a technique what is called Wi-Fi STA/STA simultaneous connection. Such Wi-Fi STA/STA simultaneous connection enables to designate and use a Wi-Fi network different from a Wi-Fi network set and managed by an OS for each application without disconnecting the connection of the Wi-Fi network set and managed by the OS. The Wi-Fi network managed by the OS is referred to as a primary network, and the different Wi-Fi network is referred to as a secondary network.

In the above-described two publications, the Internet environment is maintained by the primary network in which the application performs Wi-Fi communication with an external apparatus such as a printer. Then, while maintaining the Internet environment by the primary network, an external apparatus is connectable by the secondary network. Such a communication technique is important. For example, there is a proposed mechanism in which a smartphone with the Android (registered trademark) OS is connectable to the secondary network for each application separately from the primary network managed by the OS.

In this way, it is assumed that the secondary network is designated and used by the application. Therefore, an inter-application cooperating operation in which each application performs Wi-Fi communication with an external apparatus may cause the following problem. That is, when a first application as a cooperation source performs Wi-Fi communication with an external apparatus using the secondary network, the second application as a cooperation destination normally communicates using the primary network. Therefore, the Wi-Fi communication with the external apparatus using a desirable network may be unavailable.

That is, in a case where content data is externally output under the inter-application cooperation, when the secondary network is set in the first application as the cooperation source, it is assumed that the second application as the cooperation destination externally outputs content data to the secondary network. However, such external output cannot be performed unless the same secondary network as that of the first application is set in the second application. Here, the external output of the content data means data transmission to the external apparatus. For example, it means a case where an image selected and designated to print with an image browser application is taken over to a printer driver application to transmit to a printer and is printed.

### SUMMARY OF THE INVENTION

The present invention provides a mechanism that enables data transmission to an external apparatus more appropriately when a cooperation source application in which a second network is set performs an inter-application cooperating operation with a cooperation destination application.

Accordingly, an aspect of the present invention provides a non-transitory computer-readable storage medium storing a first application program causing at least one computer to function as a setting unit configured to set a second network as a connection destination in transmitting data to an external apparatus, the second network being different from a first network managed by an operating system as a connection destination, a reception unit configured to receive a cooperation instruction with a second application program, and a processing unit configured to execute a specific process causing the second application program to obtain the connection information for connecting to the second network set by the setting unit when a process of the second application program is executed based on the cooperation instruction received by the reception unit.

According to the present invention, when the cooperation source application in which the second network is set performs the inter-application cooperating operation with the cooperation destination application, data transmission to the external apparatus is performed more appropriately.

Further features of the present invention will become apparent from the following description of exemplary embodiments with reference to the attached drawings.

### BRIEF DESCRIPTION OF THE DRAWINGS

FIGS. 1A and 1B are block diagrams respectively showing a hardware configuration and a software configuration of an information processing apparatus (a mobile terminal) according to an embodiment of the present invention.

FIGS. 2A, 2B, and 2C are explanatory views showing inter-application cooperation examples (first, second, and third examples) in the embodiment of the present invention.

FIG. 3 is a flowchart showing a process executed by the information processing apparatus according to the embodiment of the present invention when a cooperation activation operation of an application B is received during an operation of an application A.

FIG. 4 is a flowchart showing a process executed when the information processing apparatus according to the embodiment of the present invention activates the application B.

FIG. 5 is an explanatory view showing a display screen that a store application displays in the information processing apparatus according to an embodiment of the invention.

FIG. 6 is an explanatory view showing a display screen that an application A displays in the information processing apparatus according to an embodiment of the invention.

### DESCRIPTION OF THE EMBODIMENTS

Hereafter, embodiments according to the present invention will be described in detail by referring to the drawings. However, configurations described in the following embodiments are merely examples, and the scope of the present invention is not limited by the configurations described in the embodiments. In this specification, a cooperation source application and a cooperation destination application respectively correspond to an activation source application and an activation destination application. Further, there are a case where either a cooperation source application (cooperation destination application) or an activation source application (activation destination application) is used and a case where both of them are used.

First, an information processing apparatus to which the present invention is applied will be described. The mobile terminal 100 is described as an example of the information processing apparatus in this embodiment, the information processing apparatus is not limited thereto. Examples of the information processing apparatus include various devices capable of installing a program, such as a notebook PC, a tablet terminal, a personal digital assistant (PDA), a digital camera, a music player, and a television. In this embodiment, a smartphone is shown as an example of the mobile terminal 100. The smartphone is a multifunctional mobile phone having various functions, such as a camera function, an Internet browser function, and a mail transmission/reception function, in addition to a function as a mobile phone, and is an example of a mobile terminal.

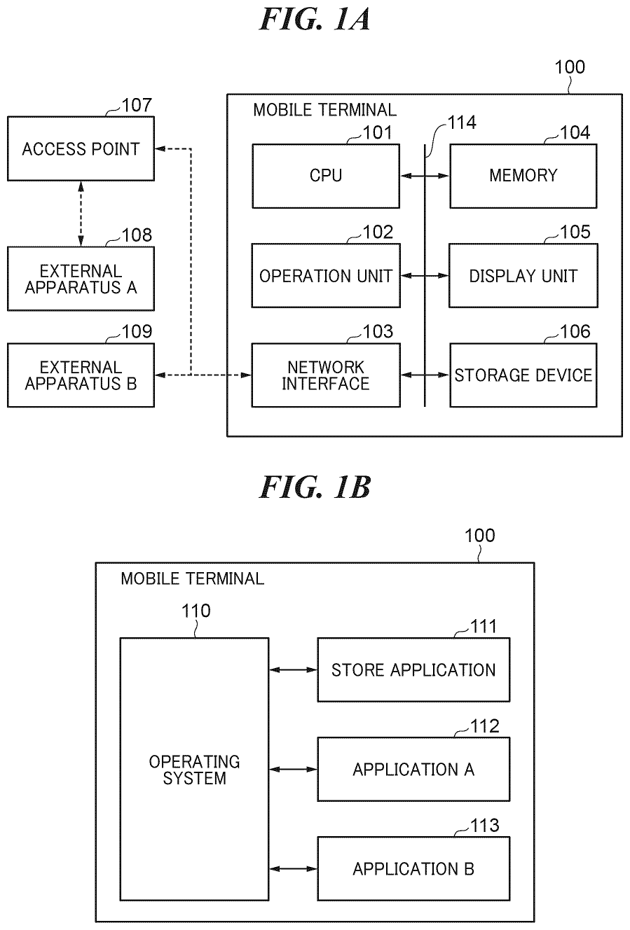

FIGS. 1A and 1B are block diagrams showing configuration examples of the mobile terminal 100 as the information processing apparatus according to the embodiment of the present invention. FIG. 1A shows an example of a hardware configuration of the mobile terminal 100, and FIG. 1B shows an example of a software configuration of the mobile terminal 100. The mobile terminal 100 includes a CPU 101, an operation unit 102, a network interface 103, a memory 104, a display unit 105, and a storage device 106. These components are mutually connected via a bus 114 so as to enable transmission and reception of required information.

The CPU 101 controls the entire mobile terminal 100. The operation unit 102 is used by a user to give an instruction to the mobile terminal 100. The operation unit 102 is constituted by, for example, physical buttons or a touch panel including soft buttons. The memory 104 has a work area for the CPU 101, is used as a temporary storage area for various received date, stores various data, and also serves as a development area for programs. The memory 104 is a random access memory (RAM), for example.

The display unit 105 is a display device that displays various pieces of information, and is a liquid crystal panel, for example. In this embodiment, the operation unit 102 and the display unit 105 share one touch device, and can receive an operation by the user and display various pieces of information. That is, the operation unit 102 and the display unit 105 are configured to share one touch display. Therefore, the user can give various instructions to the mobile terminal 100 by an operation of tracing the touch display with a finger, a tap operation of touching a display button, etc. and operate the mobile terminal 100. The user can also give various instructions to the mobile terminal 100 by operating the touch display with a member other than the finger, for example, an electrostatic touch panel pen such as a stylus pen. The operation unit 102 and the display unit 105 may not share the same device, and for example, the operation unit 102 may be configured to include physical input buttons.

The storage device 106 stores various control programs, such as applications and an operating system (hereinafter also referred to as OS). The storage device 106 is a nonvolatile memory device such as a flash memory. Processes necessary for the mobile terminal 100 are executed by the CPU 101 developing the control programs stored in the storage device 106 onto the memory 104 and running the developed control programs. The necessary processes include various processes related to the present invention. Therefore, the storage medium storing the control program is a subject matter of the present invention.

The network interface 103 is an interface for connecting to a network. The mobile terminal 100 is connectable to a network via the network interface 103, and is connectable to an external apparatus, such as a printer, via the connected network, and is also connectable to the Internet. The mobile terminal 100 is connected to an access point (AP) 107 for Internet connection via the network interface 103, for example. There are a connection mode in which the network interface 103 connects to an external apparatus A 108, such as a printer, via the access point 107, a connection mode in which the network interface 103 directly connects to an external apparatus B 109, such as a printer, that activates an access point mode, etc. The mobile terminal 100 can communicate with the external apparatus A 108 and the external apparatus B 109 via the network interface 103 in any connection mode.

When performing data transmission and reception with the external apparatus A 108 via the access point 107 connected to the Internet, the mobile terminal 100 can perform data transmission and reception via both the Internet communication such as downloading of print date from a cloud server and the data communication with the external apparatus B 109. In the meantime, when the external apparatus B 109 is in the access point mode and directly connected to the network interface 103, an Internet routing function is not provided. That is, generally, when the external apparatus B 109 operates in the access point mode, the external apparatus B 109 does not have the Internet routing function. Therefore, when the mobile terminal 100 does not have another connection method such as cellular data communication, the Internet communication may be limited, which is a problem.

In recent years, in order to cope with such a problem, an OS to be installed in the mobile terminal 100 that allows the mobile terminal 100 to simultaneously connect to a plurality of access points (corresponding to the access point 107 and the external apparatus B 109 in FIG. 1) via the network interface 103 is proposed. Such a function is referred to as an STA/STA simultaneous connection function. First network connection (referred to as primary network connection) is connection to the access point 107 capable of the Internet communication. Second network connection (referred to as secondary network connection) enables communication with the external apparatus B 109 that has activated the access point.

Normally, the connection via the secondary network is enabled by the OS according to an instruction from an application and is valid only while the application that has issued the instruction to the OS is activated. That is, an application other than the application that has issued the connection instruction to the secondary network is not affected. For example, the Android (registered trademark) OS provides the above-described functions.

As shown in FIG. 1B, the storage device 106 of the mobile terminal 100 in this embodiment stores the operating system (OS) 110, a store application 111, an application A 112, and an application B 113.

The application A 112 corresponds to a first application and the application B 113 corresponds to a second application. In addition, in this embodiment, basically, the application A 112 is the cooperation source application (activation source application) and the application B 113 is the cooperation destination application (activation destination application). The store application 111 is used to download an application to the mobile terminal 100.

The user selects a desired application using the store application 111 and performs a predetermined operation (a download button tap operation, a password authentication operation, etc.) for downloading the selected application. Thus, the selected application can be downloaded and installed in the mobile terminal 100. The user performs a predetermined operation (a tap operation, for example) to a display button (an open button, for example) displayed on the display screen of the display unit 105 by the store application 111. Thus, the application installed in the mobile terminal 100 can be activated via the store application 111.

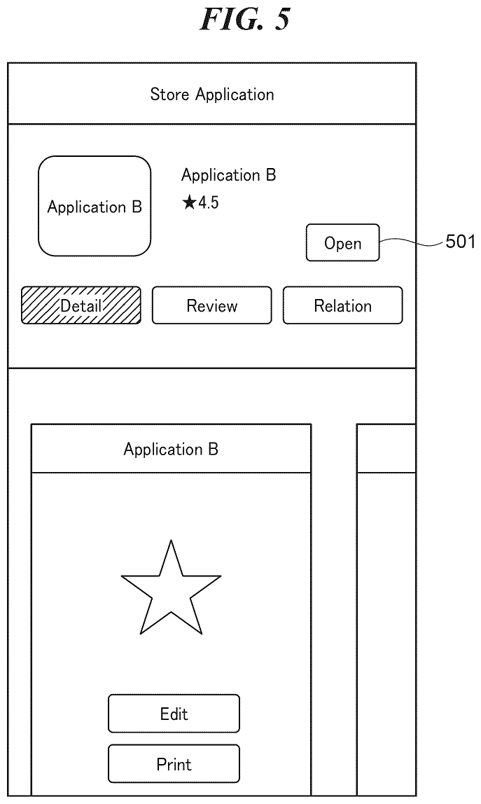

FIG. 5 is an explanatory view showing a display screen that the store application 111 displays on the display unit 105. FIG. 5 shows the display screen for executing the application B in a state where the application B is already installed in the mobile terminal 100. As described above, the application B is activated by the user tapping an open button 501. The application A 112 and the application B 113 are applications installed in the mobile terminal 100 by the store application 111 via a network etc. However, the application A 112 and the application B 113 are not necessarily installed via the store application 111. For example, the application A 112 and the application B 113 may be installed from a storage medium storing them or may be stored in the mobile terminal 100 in advance when the mobile terminal 100 is purchased and delivered.

In this embodiment, the application A 112 and the application B 113 are applications for transmitting a print job to a printer having a printing function and causing the printer to execute printing based on the transmitted print job. Although the application A 112 and the application B 113 have the function of causing the printer to execute printing in this embodiment, they may have various other functions. For example, the application A 112 and the application B 113 may have a function of transmitting a scan job to a scanner and causing the scanner to execute scanning based on the transmitted scan job.

The store application 111, application A 112 and application B 113 are operated via the OS 110. These software programs are stored in the storage device 106, and are developed onto the memory 104 and executed by the CPU 101.

In this embodiment, the application A 112 and the application B 113 operate cooperatively. Specifically, the application B 113 operates using information generated by the application A 112. Hereinafter, the cooperating operation of the applications is referred to as inter-application cooperation. Hereinafter, examples of the inter-application cooperation in use cases will be described. The application A 112 is a cooperation source application, and the application B 113 is a cooperation destination application.

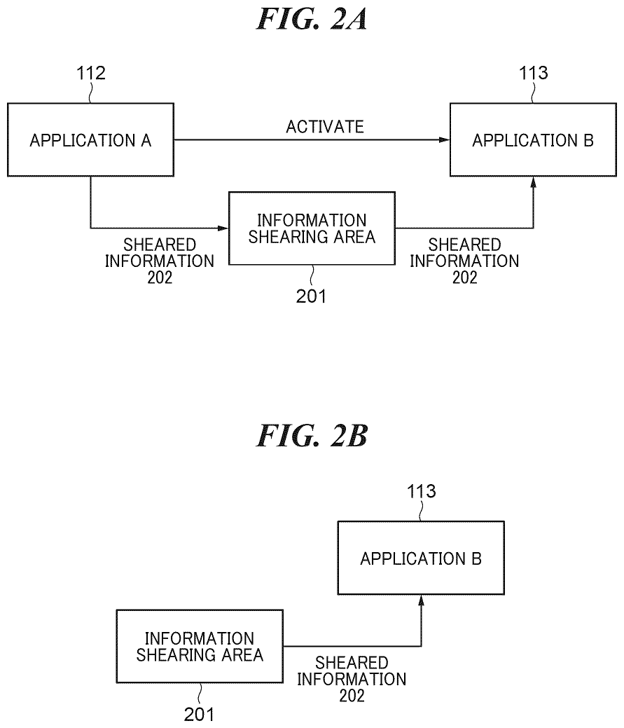

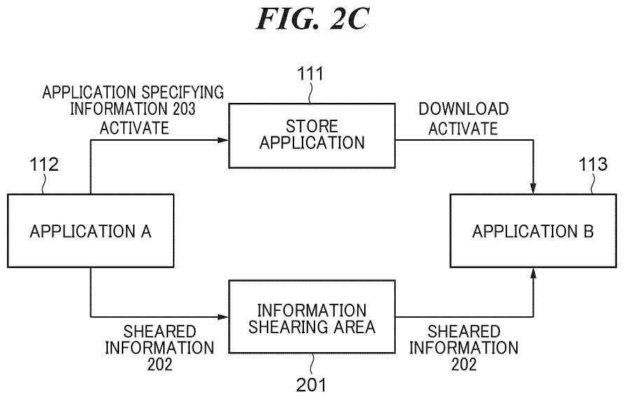

FIG. 2A is an explanatory view showing the inter-application cooperation in a case where the application B 113 is cooperatively activated as a cooperation destination in a state where the application A 112 and the application B 113 are already installed in the mobile terminal 100. FIG. 2B is an explanatory view showing the inter-application cooperation in a case where the application B 112 is independently activated in the state where the application A 112 and the application B 113 are already installed in the mobile terminal 100. FIG. 2C is an explanatory view showing the inter-application cooperation in a case where the application B 113 is cooperatively activated in a state where the application B 113 is not installed in the mobile terminal 100.

The independent activation means that the application B 113 is activated by, for example, a tap operation by the user to an application icon on a home screen displayed on the display unit 105 by the OS 110. Alternatively, the independent activation means that the store application 111 is activated by the user giving an operation on the display screen of the display unit 105. In the meantime, the cooperative activation means that the application B 113 is activated by a user operation to a display screen displayed on the display unit 105 by an application other than the store application 111.

In this embodiment, the application B 113 is cooperatively activated in response to a user operation to a display screen displayed on the display unit 105 by the application A 112. When the cooperation activation is performed, the information of the application A 112 that becomes the cooperation source is reported, and thus the CPU 101 can grasp whether the application B 113 that is a cooperation destination application is cooperatively activated. The cooperative activation is, for example, to cause another application to execute a function that cannot be executed by the application A 112. Alternatively, the cooperative activation is performed to prompt use of another application (the application B 113) when a process executed in the application A 112 is taken over to the other application.

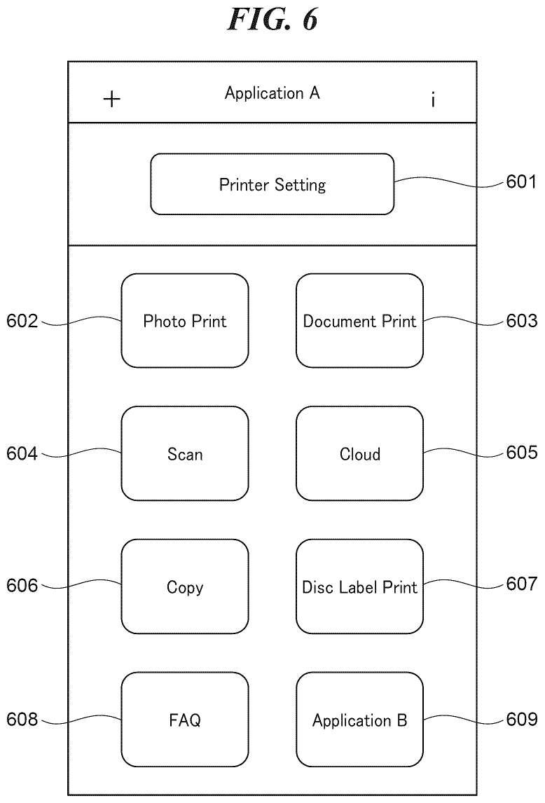

FIG. 6 is an explanatory view showing a display screen that the application A 112 displays on the display unit 105. In the display screen in FIG. 6, various icons indicated by reference numerals 601 to 609 are displayed. The icon 601 (a printer setting icon) is a button for setting a printer registered in the application A 112. Registration of a printer will be described later. The icon 602 and the icon 603 are buttons for transmitting a print job to the printer registered in the application A 112 and causing the printer to print photos and documents stored in the mobile terminal 100.

The icon 604 is a button for transmitting a scan job to a multi-function printer registered in the application A 112 and causing the multi-function printer to execute scanning. The icon 605 is a button for executing a cloud print function of causing the printer to print image data stored in a cloud server (an external server). The icon 606 is a button for transmitting a copy job to the printer registered in the application A 112 to create a copy of a document. The icon 607 is a button for transmitting a print job to the printer and causing the printer to execute printing on a disc medium. For example, another application (a disk medium printing application) other than the application A 112 may be necessary to print on a disk medium.

In such a case, when the CPU 101 receives a user operation to the icon 607 in a state where the disk medium printing application is installed in the mobile terminal 100, the disk medium printing application is cooperatively activated. The icon 608 is a button for launching a web page indicating an operation method of the application A 112. The icon 609 is a button for cooperatively activating the application B 113. When the CPU 101 receives a user operation to the icon 609 in a state where the application B 113 is installed in the mobile terminal 100, the application B 113 is cooperatively activated. For example, when a printer that is not compatible with the application B 113 is registered in the application A 112, the CPU 101 grays out or hides the icon 609. This prevents reception of the user operation to the icon 609.

Hereinafter, examples of the inter-application cooperation are described with reference to FIGS. 2A, 2B, and 2C. The first example of the inter-application cooperation will be described with reference to FIG. 2A. FIG. 2A shows a case where the application B 113 is cooperatively activated via the application A 112 in a state where the application A 112 and the application B 113 are already installed in the mobile terminal 100.

First, when the CPU 101 specifies that the application B 113 is to be cooperatively activated by, for example, receiving a user operation to the icon 609 (see FIG. 6) through the operation unit 102, the CPU 101 stores and saves shared information 202 in an information sharing area 201. The CPU 101 can refer to and use the shared information 202 during both the operation of the application A 112 and the operation of the application B 113.

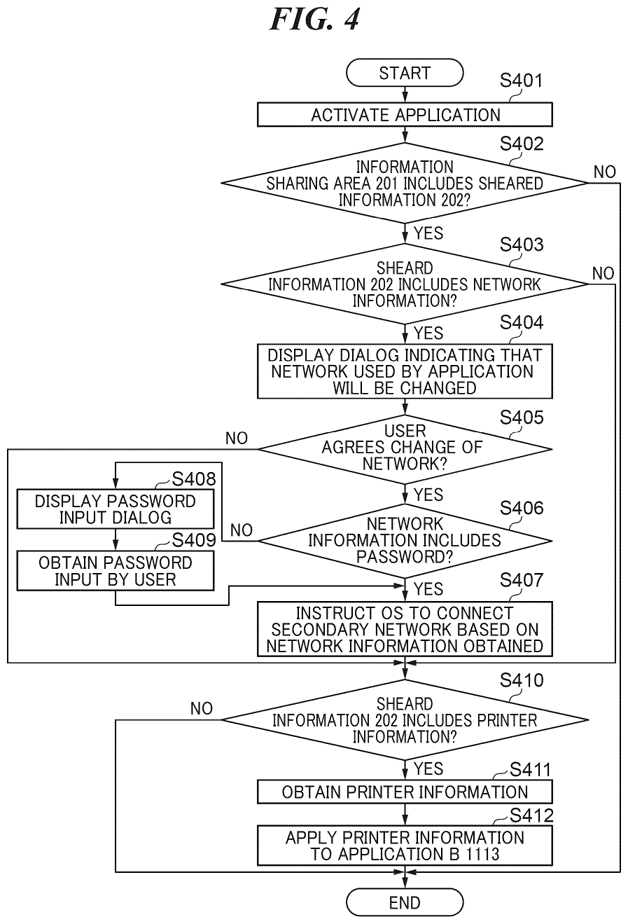

The shared information 202 is information for communicating with an external apparatus, such as a printer, using the secondary network set to the application A 112. The shared information 202 includes connection information, printer information, etc. The connection information is information for connecting to the secondary network, such as an SSID (a Service Set Identifier) of the secondary network set to the application A 112, an IP addresses of the external apparatus (AP), a MAC addresses of the external apparatus (AP), and passwords (a network key, an authentication code) for connecting to the secondary network. The printer information is information about the printer, such as a type of the printer and network addresses of the printer (an IP address and a MAC address of the printer). The connection information is synonymous with network information. For example, the connection information is described as the network information in S403 in FIG. 4. Therefore, the connection information may be referred to as the network information (connection information) or the connection information (network information). Further, the connection information and the printer information may be collectively referred to as registration information. In this embodiment, the shared information 202 also includes all other information that the application A 112 and the application B113 need to refer and store.

Further, the information sharing area 201 is a storage area in which the shared information 202 is stored and saved. The information sharing area 201 may be, for example, a common folder accessible during both the operation of the application A 112 and the operation of the application B 113, or may be a clipboard, a pasteboard, or the like managed by the OS. Basically, the information sharing area 201 is provided in the storage device 106 or the memory 104.

Further, although the common folder is an area included in the storage device 106 or the memory 104, it may be provided in a storage area included in an external storage medium, such as an SD card or an HDD, or may be provided in a storage area of a server connected to the network. A storage mode of the shared information 202 has no limitation as long as the information usable during both the operation of the application A 112 and the operation of the application B 113 can be stored. When the information sharing area 201 becomes full with the shared information 202, the shared information 202 may be deleted at a timing when the shared information 202 is used or a timing when the activation of the application B 113 cooperatively activated is terminated. Then, when the application B 113 is cooperatively activated, the CPU 101 obtains the shared information 202 by referring to the information sharing area 201 via the application B 113, and executes the process based on the shared information 202.

As described above, the application A 112 and the application B 113 have the printing function of causing a printer communicable with the mobile terminal 100 to print an image. The application A 112 and the application B 113 search the network near the mobile terminal 100 for printers and register a printer (a printing apparatus) to be used to print from among the printers searched for, and thus can execute the printing function. Here, the search for a printer is the same as obtaining a response from an external apparatus (a printer) connected to the access point 107 connected via the network interface 103 described above.

The process of registering a printer to an application is, in other words, a process of setting a communication mode with the printer by the application (a setting process). The setting process is, for example, a process of setting a secondary network, which is different from a primary network managed as a connection destination by the operating system (OS 110), as a connection destination in transmitting data to an external apparatus (a printer). More specifically, the setting process is a process of setting an SSID (Service Set Identifier) of the secondary network, etc.

In the example of the inter-application cooperation shown in FIG. 2A, the printer information or the connection information (network information) registered in the application A 112 can be used by the application B 113 as the shared information 202. As described above, the printer information includes a model name, a MAC address, an IP address, and a Bonjour name of the printer. Then, the CPU 101 performs the process of registering the printer information registered in the application A 112 in the application B 113 as the process based on the shared information 202 at the time of the cooperation activation of the application B 113. Such a cooperation mode allows the CPU 101 to register the printer in the application B 113 without causing the application B 113 to execute the processing of searching for the printer, for example. Similarly, the process of registering the connection information (network information) registered in the application A 112 in the application B 113 is performed.

In performing the inter-application cooperating operation, the connection information stored in the information sharing area 201 by the application A 112 basically indicates to connect to an access point different from the access point (primary network) set in the OS 110. As an example of this, there is a case where direct connection is used. The direct connection is a connection mode in which the printer starts the access point mode to function as an access point and the printer and the mobile terminal 100 are connected directly. The direct connection has an advantage that wireless communication is stable without being affected by connection performance of an external access point because a printer and a smartphone (mobile terminal 100) directly communicate with each other wirelessly.

When communication connection with the printer (external apparatus) is established using such a function, connection via the access point is established as the primary network, and the direct connection is established as the secondary network. As described above, the secondary network is valid only in the application that instructs the connection. In such a case, it is necessary to add new connection information indicating a connection method to the secondary network to the connection information included in the shared information 202. This is because, when the connection information about the secondary network is not included in the shared information 202 stored in the information sharing area 201, the application B 113 of the cooperation destination cannot connect to the secondary network and can use only the primary network.

Since the communication with the printer is not established when only the primary network is available, the CPU 101 has to perform the process from the search process again. Therefore, it is very important that the CPU 101 additionally stores the shared information 202 about the secondary network in the information sharing area 201 for the operation of the inter-application cooperation that communicates with the external apparatus connected via STA/STA connection. Note that, in a case where the entire registration information cannot be stored in the information sharing area 201, minimum information for transmitting data to the printer (external apparatus) may be stored and saved in the information sharing area 201 as the shared information 202. For example, the connection information to the secondary network basically includes an SSID and passwords (a network key and an authentication code), but only the SSID may be stored in the information sharing area 201. In this case, the passwords may be obtained by the CPU 101 prompting the user to input the passwords. The same applies to the printer information, and at least only the IP address of the printer may be stored in the information sharing area 201.

A concrete process of the first example of the inter-application cooperation is as follows. First, when the application A 112 as the cooperation source application uses the secondary network different from the primary network managed by the OS 110, the CPU 101 executes the following process. That is, the application A 112 records the shared information 202 including the printer information and connection information, which are necessary for data communication with the external apparatus such as a printer via the secondary network, in the information sharing area 201 of the memory 104 (a recording step). The storage area of the storage device 106 may be used instead of the memory 104. Next, the application A 112 activates the application B 113 that is the cooperation destination application (an activation step).

Next, the activated application B 113 instructs the OS 110 to connect to the secondary network set in the application A 112 based on the shared information 202 stored in the information sharing area 201 (an instruction step). Then, the application B 113 refers to the shared information 202 stored in the information sharing area 201, connects to the secondary network set in the application A 112, and transmits data to the printer (a transmission step). The shared information 202 includes the connection information including the SSID (Service Set Identifier) and the passwords of the secondary network set in the application A 112. Further, the shared information 202 includes the printer information (transmission destination information) including the type of the printer, the IP address and MAC address of the printer (external apparatus serving as data transmission destination) on the secondary network set in the application A 112.

When the application A 112 as the cooperation source application performing the inter-application cooperation by such an operation activates the application B 113 as the cooperation destination application, the following is possible. That is, when the inter-application cooperating operation is performed, the information about the network set in the application A 112 as the cooperation source application is taken over to the application B 113 as the cooperation destination application. Thus, the data transmission to the printer (external apparatus) by the inter-application cooperating operation is appropriately performed through the secondary network set in the application A 112.

Next, the second example of the inter-application cooperation will be described with reference to FIG. 2B. FIG. 2B shows a case where the application B 113 is independently activated regardless of the application A 112 in a state where the application A 112 and the application B 113 are already installed in the mobile terminal 100. The operation of the CPU 101 will be described below.

As with FIG. 2A, when the CPU 101 specifies that the application B 113 is to be cooperatively activated by, for example, receiving a user operation to the icon 609 (see FIG. 6) through the operation unit 102, the CPU 101 stores and saves the shared information 202 in the information sharing area 201. In the second example of the inter-application cooperation in FIG. 2B, the CPU 101 refers to the stored contents in the information sharing area 201 even when the application B 113 is independently activated. Then, when the shared information 202 is stored and saved in the information sharing area 201, the CPU 101 obtains the shared information 202 and executes a process based on the shared information 202.

As described above, in the second example of the inter-application cooperation, the CPU 101 refers to the information sharing area 201 when the application B 113 is activated, regardless of whether the application B113 is activated independently or cooperatively. Thus, the inter-application cooperation with the application A 112 can be executed even when the application 113 is activated independently or cooperatively.

Next, the third example of the inter-application cooperation will be described with reference to FIG. 2C. FIG. 2C shows a case where the user operation to cooperatively activate the application B 113 is performed on the display screen that the application A 112 displays on the display unit 105 in a state where the application B 113 is not installed in the mobile terminal 100. The operation of the CPU 101 will be described below. Even if the user operation to cooperatively activate the application B 113 is performed on the display screen that the application A 112 displays on the display unit 105, the CPU 101 cannot activate the application B 113 because the application B 113 is not installed in the mobile terminal 100.

In order to install the application B 113 in the mobile terminal 100, it is basically necessary to use the store application 111. Therefore, when the user operation to cause the application A 112 to cooperatively activate the application B 113 is performed on the display screen of the display unit 105 in the state where the application B 113 is not installed in the mobile terminal 100, the CPU 101 executes the following process.

First, the CPU 101 controls the application A 112 to store and save the shared information 202 in the information sharing area 201 before activating the store application 111. Next, the CPU 101 activates the store application 111. The CPU 101 activates the store application 111 using identification information (application identification information 203) for identifying an application to be a download object (hereinafter referred to as an object application). As a result, a display screen for downloading the object application is displayed on the display unit 105.

At this time, the CPU 101 activates the store application 111 using the application identification information 203 in which the object application is set as the application B 113. As a result, the display screen for downloading the application B 113 is displayed on the display unit 105, and thus when accepting the user operation to the operation unit 102, the CPU 101 downloads the application B 113. At this time, the CPU 101 may automatically download the application B 113 without receiving the user operation to the operation unit 102.

Thereafter, the CPU 101 accepts a user operation to an application icon corresponding to the application B 113 on a home screen of the display unit 105 or a user operation on the display screen displayed by the store application 111 on the display unit 105 (an operation to the button 501 in FIG. 5, etc.). Then, the CPU 101 activates the application B 113 in response to these operations, and executes the same process as the process shown in FIG. 2B. That is, the CPU 101 executes the process in the case where the application B 113 is independently activated.

In this way, the CPU 101 performs the following operation in the state where the application B 113 is not installed in the mobile terminal 100. That is, when the user operation to cooperatively activate the application B 113 is performed on the display screen that the application A 112 displays on the display unit 105, the CPU 101 downloads the application B 113 by using the store application 111.

When the application B 113 is cooperatively activated, the CPU 101 links the application A 112 with the application B 113 by using the shared information 202. In the cooperation mode shown in FIG. 2C, the CPU 101 refers to the information sharing area 201 even if the application B 113 is independently activated as shown in FIG. 2B. Therefore, even when the application B 113 is independently activated in spite of the user operation to cooperatively activate the application B 113, the application A112 and the application B113 can be operated cooperatively.

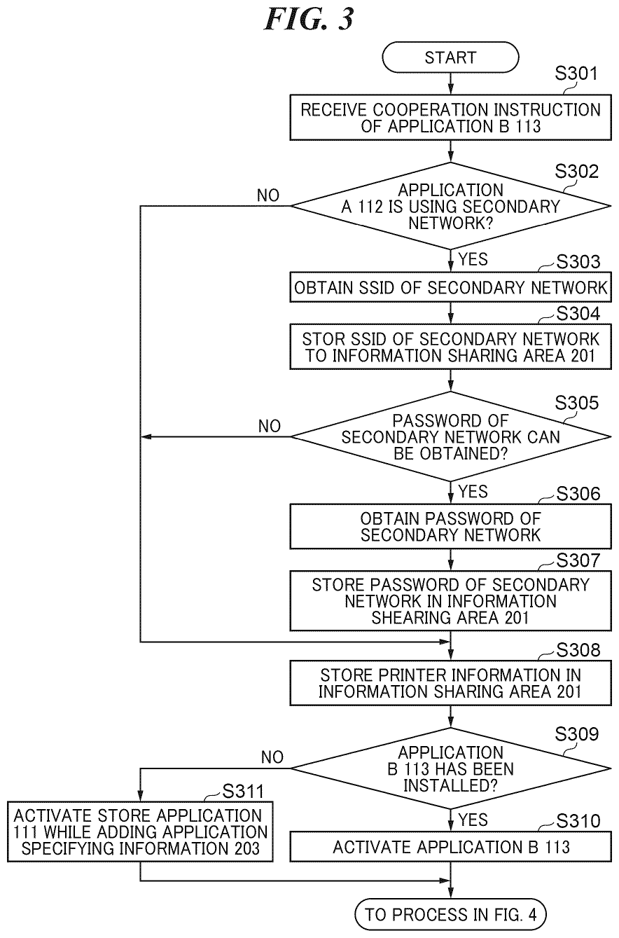

FIG. 3 is a flowchart showing a process executed by the mobile terminal 100 when the cooperation activation operation of the application B 113 is accepted during the operation of the application A 112. The process shown in this flowchart is achieved by, for example, the CPU 101 reading the program of the application A 112 stored in the storage device 106, developing the program onto the memory 104, and executing the program.

In addition, the process shown in this flowchart shall start in a state where the display screen for executing the function of the application A 112 is displayed on the display unit 105 by the application A 112. Here, the application A 112 has a function to set the secondary network used by the application A 112 independently from the primary network managed by the OS (that is, as a network regardless of the primary network managed by the OS).

More specifically, at least an SSID of the secondary network can be set according to a user operation. In addition, passwords (a network key and an authentication code) of the secondary network, a BSSID (Mac address) of a connection destination AP, a nickname, and the like may be set. The setting of the secondary network is equivalent to a setting of a second access point (AP) that is set separately from the first access point (AP) connected by the primary network.

It is basically envisioned that the primary network and the secondary network are different, but they may not be different. The OS connects to a suitable AP (connects to a suitable network as the primary network) according to a radio wave condition. It is allowed that the connected network is eventually the same network set as the secondary network in the application A 112.

In S301, the CPU 101 accepts a user operation (cooperation instruction) for cooperative activation of the application B 113. Specifically, the CPU 101 accepts a user's touch operation to the icon 609 through the operation unit 102 as the cooperation instruction.

In S302, the CPU 101 determines whether the application A 112 is using the secondary network. When the CPU 101 determines that the application A 112 sets the secondary network and is using (validates) the secondary network (Yes), the process proceeds to S303. In the meantime, when the CPU 101 determines that the application A 112 is not using the secondary network (the secondary network is not set or is set but invalidated) (No), the process proceeds to S308 while skipping S303 to S307 (that is, the process in S303 to S307 is not performed). When the application A 112 is not using the secondary network, communicate with the printer is possible via the network set by the OS 110, and there is no need to perform any special process for the following process.

Since the secondary network is connected by an instruction from an application, the fact that the application itself that issued the instruction is using the secondary network is stored in the memory 104 by setting a flag. The CPU 101 may refer to the flag to determine in S302. Alternatively, the CPU 101 may inquire of the OS 110 to determine in S302.

Also, when the network information (primary network information) set by the OS 110 differs from the network information currently being used by the application A 112, it may be determined that the application A 112 is using the secondary network. Here, when the CPU 101 determines that the secondary network is used (Yes in S302), the application A 112 communicates with the printer via a network different from the network set by the OS 110.

In S303, the CPU 101 obtains the SSID of the secondary network that the application A 112 is using. In S304, the CPU 101 stores the SSID (connection information for connecting to the secondary network set in the application A) obtained in S303 in the information sharing area 201. This SSID is the SSID of the access point of the secondary network set in the application A. By this process (specific process), the application B of the cooperation destination obtains (is notified of) the connection information for connecting to the secondary network set in the application A.

In S305, the CPU 101 determines whether the password of the secondary network can be obtained. When the CPU 101 determines that the password can be obtained (Yes), the process proceeds to S306. In the meantime, when the CPU 101 determines that the password cannot be obtained (No), the process proceeds to S308 while skipping S306 and S307. In S306, the CPU 101 obtains the password of the secondary network used by the application A 112. In S307, the CPU 101 stores the password obtained in S306 in the information sharing area 201.

In S308, the CPU 101 records the printer information described above to the information sharing area 201. In this embodiment, the printer information is recorded in the information sharing area 201 in both the cases where the determination result in S302 is “Yes” and “No”. In S308, the CPU 101 further stores information specifying (designating) processing target data (an image, a WEB page, etc. to be printed) instructed to be cooperated in the information sharing area 201. In this embodiment, the processing target data is, for example, data to be printed. As another example, in a case where the cooperation source application is image browsing software and the cooperation is an instruction to print a browsed image by a printer, the information specifying the processing target data is information for specifying the browsed image (information indicating a save location and a file name).

In S309, the CPU 101 determines whether the application B 113 is installed in the mobile terminal 100. When the CPU 101 determines that the application B 113 is installed in the mobile terminal 100 (Yes in S309), the process proceeds to S310. In the meantime, when the CPU 101 determines that the application B 113 is not installed in the mobile terminal 100 (No in S309), the process proceeds to S311.

In S310, the CPU 101 activates the application B 113. Thereafter, the CPU 101 continuously executes a process shown in FIG. 4, which will be described later, by the application B 113.

In S311, the CPU 101 activates the store application 111 in a known manner, for example, using a URL scheme. At this time, the store application 111 is activated while the store application 111 adds the application specifying information 203 for specifying the application B 113 the URL scheme. As a result, a screen for downloading the application B 113 is displayed on the display unit 105 at the same time as the activation of the store application 111. When a user operation for downloading the application B 113 is accepted through the operation unit 102 in this state, the CPU 101 becomes able to download and install the application B 113 and activate the application B 113. Thereafter, the CPU 101 continuously executes the process shown in FIG. 4, which will be described later, by the application B 113.

FIG. 4 is a flowchart showing a flow of the process executed when the mobile terminal 100 activates the application B 113. This flowchart is implemented by, for example, the CPU 101 developing a program of the application B 113 stored in the storage device 106 to the memory 104 and executing the program. As with the application A 112, a secondary network of the application B 113 can be set as a function of the application B 113. The secondary network of the application B 113 can be set independently from both the secondary network of the application A 112 and the primary network. The primary network can be referred to as a first network. The secondary network of the application A 112 and the secondary network of the application B 113 can be referred to as a second network and a third network, respectively.

In S401, the CPU 101 activates the application B 113. The process in S401 is executed by the CPU 101 in response to a trigger, which is reception of a user operation through the operation unit 102 for the cooperative activation of the application B 113 via the application A 112. Alternatively, the trigger may be reception of an instruction to activate the application B 113 via the store application 111 or reception of an instruction to activate the application B113 on the home screen of the display unit 105.

In the S402, the CPU 101 determines whether the information sharing area 201 includes the shared information 202. When the CPU 101 determines that the shared information 202 is included in the information sharing area 201 (Yes), the process proceeds to S403. In the meantime, when the CPU 101 determines that the shared information 202 is not included in the information sharing area 201 (No), the process in FIG. 4 ends. In this case, the application B shall be connected to the secondary network set in the application B or the primary network to operate.

In S403, the CPU 101 determines whether the shared information 202 includes network information (connection information). This network information (connection information) corresponds to the information (connection information) regarding the secondary network of the application A 112 stored in S304 or S307 in FIG. 3. When the CPU 101 determines that the network information (connection information) is included in the shared information 202 (Yes), the process proceeds to S404. In the meantime, when the CPU 101 determines that the network information (connection information) is not included in the shared information 202 (No), the process proceeds to S410. In this case, the application B shall be connected to the secondary network set in the application B or the primary network to operate.

In S404, the CPU 101 displays a dialog indicating that the network used by the application will be changed on the display unit 105. As described above, since the network information (connection information) may not be stored, the presence or absence of the information is confirmed in the S404, and the process is proceeded. Specifically, in S404, a dialog for changing the network used in the application B 113 to the network indicated by the network information obtained in S403 from the primary network set by the OS 110 is displayed on the display unit 105. Generally, when a network used in an application is changed, a user's permission is often required, and a permission dialog is often displayed as a function of the OS 110.

In S405, the CPU 101 determines whether there is a user operation to permit the network change. When there is the operation corresponding to the permission, the process proceeds to S406. In the meantime, when there is an operation corresponding to disapproval (an operation corresponding to rejection), the process proceeds to S410.

In S406, the CPU 101 determines whether the network information (connection information) included in the shared information 202 includes password information. When it is determined that the password information is included in the network information (connection information) (Yes), the process proceeds to S407. When it is determined that the password information is not included in the network information (connection information) (No), the process proceeds to S408.

In S407, the CPU 101 instructs the OS 110 to connect to the secondary network based on the network information (connection information) obtained as the shared information 202 and the password included in the shared information 202 or the password obtained in S409 described below.

In S408, the CPU 101 displays a password input dialog on the display unit 105. And then in S409, the CPU 101 obtains the password input in the dialog by the user. That is, when it is determined that the password information is not included in the network information (connection information) (No in S406), the CPU 101 needs to obtain the password input by the user via the dialog displayed on the display unit 105 in S408 and S409.

When the secondary network is used in the application A 112 because of the above-described process in S407, it is possible to automatically cause the application B 113 to participate in the same network. In the meantime, when it is determined that the network information (connection information) is not included in the shared information 202 in the S403 (No), the process in S407 is not performed. As a result of this, the application B 113 operates in the network (primary network) set by the OS 110. As described above, in this embodiment, the network in which the application B 113 operates varies depending on the result of the determination in S403.

In S410, the CPU 101 determines whether the shared information 202 includes the printer information (destination information about processing target data). When it is determined that printer information is included in the shared information 202 (Yes), the process proceeds to S411. In the meantime, when it is determined that the printer information is not included in the shared information 202 (No), the process ends.

In S411, the CPU 101 obtains the printer information from the shared information 202. And then in S412, the CPU 101 applies the obtained printer information to the application B 113. That is, in S412, the processing target data (data such as an image or a WEB page to be printed) instructed from the application A 112 is converted into print date interpretable by the printer indicated by the printer information obtained in S411. Then, the data is transmitted to the printer indicated by the printer information obtained in S411.

When a printer is specified in the application A 112, the same printer information is automatically applied to the application B 113 according to the process in S410, S411 and S412 executed by the CPU 101 and the same printer becomes available. Thus, the application B 113 activated cooperatively achieves a seamless operation as if it is a part of the application A 112.

Further, when the network information (connection information) and printer information stored as the shared information 202 is once applied to the application B 113, the application B 113 may store the information. Then, when the application B 113 is activated next time, the information obtained in the past may be automatically applied without using the shared information 202. In this case, the CPU 101 may execute the process shown in FIG. 4 only at the first time of the cooperative activation, and thereafter, the process shown in FIG. 4 does not need to be executed every time the application B113 is activated. Therefore, there is an advantage of speeding up the application activation.

Next, a first specific operation example will be described. If the secondary network is not set by the CPU 101, the CPU 101 performs the following process. That is, when the CPU 101 controls the application B 113 to activate, the CPU 101 does not notify the application B 113 of the connection information for connecting to the secondary network. For example, when the CPU 101 determines “No” in S302 in FIG. 3, the connection information (network information) to the secondary network is not stored in the information sharing area 201 because the process in S304 to S307 is skipped. Therefore, when the CPU 101 controls to activate the application B 113 in S310, the determination result in S403 in FIG. 4 is “No”, and the application B 113 is not notified of the connection information (network information) to the secondary network. Thus, when the CPU 101 does not set the secondary network, the application B 113, which is the cooperation destination application, is not notified of the connection information, and therefore, it is unnecessary to execute a useless process.

Next, a second specific operation example will be described. When the CPU 101 determines “No” in S302 in FIG. 3, the process in S304 to S307 is skipped, and thus the connection information (network information) to the secondary network of the application A 112 is not stored in the information sharing area 201. Therefore, the application B 113 cannot read the network information (connection information) in S402, and the connection information (network information) is not given from the application A112. In this case, the activated application B 113 is connected to the secondary network set in the application B 113 or the primary network, and transmits the processing target data to the external apparatus via the connected network (“No” in S403, S410 to S412). Thus, the application B 113, which is the cooperation destination application, can perform appropriate network connection in response to the notification of the connection information from the application A 112, which is the cooperation source application, and can transmit the data to the external apparatus such as a printer.

In the above-described embodiment, when the application B obtains the connection information given (shared) from the application A, the application B is connected to the secondary network of the application A indicated by the given connection information. However, when the secondary network is set in the application B, this is not limiting. Even when the connection information shared by the application A is obtained, the application B may be connected to secondary network of the application B without connecting to the secondary network of the application A to transmit processing target data to an external apparatus. Accordingly, the application B can be appropriately connected to the secondary network of the application B by prioritizing a reason for setting the secondary network of the application B (for example, the reason for limiting a network connectable by the application B).

As a case where the user intentionally sets different secondary networks for the application A 112 and the application B 113, there is the following case, for example. That is, a case where the application A 112 is directly connected to a monochrome laser printer to mainly print a document and the application B 113 is directly connected to another color inkjet printer to edit and print a photograph can be estimated. In this case, an SSID for connecting to the access point function of the monochrome laser printer is set in the secondary network of the application A 112. In the meantime, an SSID for connecting to the access point function of the color inkjet printer is set in the secondary network of the application B 113. In such a case, when the application A 112 and the application B 113 are cooperatively activated and the network setting of the application A 112 is registered in the application B 113, the network setting of the application B 113 is changed to what is not intended by the user. Therefore, the application B 113 stores and saves unique setting information (for example, information of at least one bit) indicating whether the application B 113 uniquely sets the secondary network in the memory 104 or the storage device 106.

When the CPU 101 activates the application B 113, the above-described unique setting information indicating whether the secondary network of the application B 113 is set is obtained. Then, the CPU 101 may control whether to apply the network setting of the application A 112 to the application B 113 in accordance with the determination result. This can prevent the network set in the application B 113 from being changed despite the user's intention. Further, although this embodiment has focused only on the network information, the same process can be executed for the printer information.

In the above-described embodiment, an example in which the cooperation source application and the cooperation destination application cooperate with each other when the processing target data is transmitted to the printer as the external apparatus has been described. However, this configuration is not limiting, and any method can be applied as long as the data is transmitted to the external apparatus after the inter-application cooperation is performed. For example, a cooperation source application may be a camera application, and a cooperation destination application may be a photo album creation application. In this case, the processing target data is image data captured by the camera application, and the information for specifying the processing target data shared via the shared information 202 is image information such as image data that can be arranged in a photo album. Further, the present invention is also applicable to a case where the cooperation source application is image browsing software, the cooperation destination application is an SNS (a social networking service) application, the cooperation source application shares information for specifying an image as the processing target data, and the cooperation destination application uploads the image to a server (posted to the SNS). Further, the present invention is also applicable to a case where the cooperation source application is text editor software, the cooperation destination application is a mail application, the processing target data is text, and the text is shared from the cooperation source application to the cooperation destination application and a mail is transmitted to an external server as information including the text. An external apparatus that is a transmission destination of the processing target data may be a scanner, an MFP, a copier, or the like.

In the above-described embodiment, when an operation for cooperatively activating the application B 113 is performed on the display screen displayed by the application A 112, the shared information 202 is stored and saved in the information sharing area 201. However, this configuration is not limiting. For example, the shared information 202 may be stored in the information sharing area 201 at the timing when the CPU 101 receives or generates the shared information 202.

Although the application A 112 stores the shared information 202 in the information sharing area 201 and the application B 113 obtains the shared information 202 from the information sharing area 201 in this embodiment, this configuration is not limiting. For example, the application A 112 may store the shared information 202 in a storage of a cloud server on the Internet, and the application B 113 may inquire of the storage at the time of activation to obtain required information. In this case, the shared information 202 may be obtained in a lump, or information (printer information and the like) included in the shared information 202 may be inquired one by one. Further, when the application B 113 is activated, the OS 110 may notify of the shared information 202, and the application A 112 may notify the OS 110 of the content of the shared information 202.

The various processes described above as being executed by the CPU 101 may be performed by a single piece of hardware, or may be performed by a plurality of pieces of hardware (for example, a plurality of processors, circuits having various functions) that share the processes to operate the entire apparatus. Although the present invention has been described in detail based on the preferred embodiments, the present invention is not limited to these specific embodiments, and various modifications within the scope not departing from the gist of the present invention are also included in the present invention. Furthermore, the above-described embodiments are merely examples of the present invention, and the embodiments may be combined as appropriate.

In the above-described embodiment, the example in which the present invention is applied to the mobile terminal 100 has been described, but the present invention is not limited to this example. For example, the present invention can be applied to any type of apparatus as long as the apparatus includes a plurality of applications and an OS and the plurality of applications can perform data communication with an external apparatus in cooperation with each other. That is, the present invention is applicable to various apparatuses in which a program can be installed, such as a PC, a tablet terminal, a personal digital assistant (PDA), a digital camera, a music reproduction device, and a television, as the information processing apparatus. As described above, the external apparatus may be an electronic device, such as a printer, a scanner, an MFP, or a copier. A server that is connected to a network and manages an SNS that can be searched and browsed can be an external apparatus. That is, an apparatus that can receive data and execute a corresponding process can be an external apparatus.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-111653, filed Jul. 6, 2023, which is hereby incorporated by reference herein in its entirety.

1. A non-transitory computer-readable storage medium storing a first application program causing at least one computer to function as:
a setting unit configured to set a second network as a connection destination in transmitting data to an external apparatus, the second network being different from a first network managed by an operating system as a connection destination;
a reception unit configured to receive a cooperation instruction with a second application program; and
a processing unit configured to execute a specific process causing the second application program to obtain the connection information for connecting to the second network set by the setting unit when a process of the second application program is executed based on the cooperation instruction received by the reception unit.

2. The non-transitory computer-readable storage medium storing the first application program according to claim 1, wherein the setting unit sets an SSID of the second network.

3. The non-transitory computer-readable storage medium storing the first application program according to claim 1, wherein the connection information includes an SSID of the second network.

4. The non-transitory computer-readable storage medium storing the first application program according to claim 1, wherein the connection information includes a password to connect to the second network.

5. The non-transitory computer-readable storage medium storing the first application program according to claim 1, wherein the processing unit does not execute the specific process when the second application program is executed based on the cooperation instruction received by the reception unit in a case where the second network is not set by the setting unit.

6. The non-transitory computer-readable storage medium storing the first application program according to claim 1, wherein the second application program executed based on the cooperation instruction received by the reception unit connects to the second network and transmits data to the external apparatus in a case where the connection information based on the specific process by the first application program is obtained, and connects to the first network and transmits data to the external apparatus in a case where the connection information based on the specific process by the first application program is not obtained.

7. The non-transitory computer-readable storage medium storing the first application program according to claim 1, wherein the first network is a primary network managed by the operating system, and
wherein the setting unit sets the second network as a secondary network.

8. The non-transitory computer-readable storage medium storing the first application program according to claim 1, wherein the first application program and the second application program are application programs of a smartphone.

9. A non-transitory computer-readable storage medium storing a second application program causing at least one computer to function as:
an obtaining unit configured to obtain connection information for connecting to a network that is notified from a first application program, when the second application program is executed based on a cooperation instruction from the first application program; and
a controller configured to control to connect to a second network different from a first network managed by an operating system as a connection destination and transmit data to an external apparatus based on the connection information obtained by the obtaining unit.

10. The non-transitory computer-readable storage medium storing the second application program according to claim 9, wherein the connection information includes an SSID of the second network.

11. The non-transitory computer-readable storage medium storing the second application program according to claim 9, wherein the controller controls to display an input screen to input a password by a user in a case where the connection information obtained by the obtaining unit does not include a password to connect to the second network.

12. The non-transitory computer-readable storage medium storing the second application program according to claim 9, wherein the second application program activated based on control of the first application program connects to the second network and transmits data to the external apparatus in a case where the obtaining unit obtains the connection information, and connects to the first network and transmits data to the external apparatus in a case where the obtaining unit does not obtain the connection information.

13. The non-transitory computer-readable storage medium storing the second application program according to claim 9, further causes the at least one computer to function as a setting unit configured to set a third network as a connection destination in transmitting data to the external apparatus, the third network being different from the first network managed by the operating system, and
wherein the controller controls to connect the third network and transmit data to the external apparatus even if the obtaining unit obtains the connection information in a case where the setting unit sets the third network.

14. The non-transitory computer-readable storage medium storing the second application program according to claim 9, wherein the first application program and the second application program are application programs of a smartphone.

15. An electronic device comprising:
at least one memory and at least one processor that execute a first application program to function as:
a setting unit configured to set a second network as a connection destination in transmitting data to an external apparatus, the second network being different from a first network managed by an operating system as a connection destination;
a reception unit configured to receive a cooperation instruction with a second application program; and
a processing unit configured to execute a specific process causing the second application program to obtain the connection information for connecting to the second network set by the setting unit when a process of the second application program is executed based on the cooperation instruction received by the reception unit.

16. An electronic device comprising:
at least one memory and at least one processor that function as;
a setting unit configured to set a second network as a connection destination in transmitting data to an external apparatus as a function of a first application program, the second network being different from a first network managed by an operating system as a connection destination;
a reception unit configured to receive a cooperation instruction with a second application program as the function of the first application program;
a processing unit configured to execute a specific process causing the second application program to obtain the connection information for connecting to the second network set by the setting unit as the function of the first application program when a process of the second application program is executed based on the cooperation instruction received by the reception unit;
an obtaining unit configured to obtain the connection information based on the specific process as a function of the second application program in a case where the second application program is executed based on the cooperation instruction from the first application program; and
a controller configured to control to connect to the second network based on the connection information obtained by the obtaining unit and transmit data to the external apparatus as the function of the second application program.

17. A control method for an electronic device executed based on a first application program, the control method comprising:
setting a second network as a connection destination in transmitting data to an external apparatus, the second network being different from a first network managed by an operating system as a connection destination;
receiving a cooperation instruction with a second application program; and
executing a specific process causing the second application program to obtain the connection information for connecting to the second network set when a process of the second application program is executed based on the cooperation instruction received.

18. A control method for an electronic device executed based on a second application program, the control method comprising:
obtaining connection information for connecting to a network that is notified from a first application program, when the second application program is executed based on a cooperation instruction from the first application program; and
controlling to connect to a second network different from a first network managed by an operating system as a connection destination and transmit data to an external apparatus based on the connection information obtained.
